(19) United States
(12) Patent Application Publication
(10) Pub. No.: US 2008/0136798 A1
(43) Pub. Date: Jun. 12, 2008

(54) LIQUID-CRYSTAL DISPLAY DEVICE USING A LIQUID-CRYSTAL DISPLAY PANEL AND DRIVER CIRCUIT FOR DRIVING THE LIQUID-CRYSTAL DISPLAY PANEL

(75) Inventors: Keisuke Ashida, Kamakura-shi (JP); Hidehiko Tachibana, Oita-shi (JP); Satoshi Suzuki, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/951,265

(22) Filed: Dec. 5, 2007

(30) Foreign Application Priority Data
Dec. 8, 2006 (JP) 2006-332129

(51) Int. Cl. G06F 3/038; G09G 3/36

(52) U.S. Cl. 345/204; 345/100

(57) ABSTRACT

A liquid-crystal display device comprises a liquid-crystal panel having liquid-crystal display elements at intersections of a plurality of address lines and a plurality of signal lines, a signal line driver circuit configured to drive the signal line at an image signal voltage, and an address line driver circuit configured to drive the address line by a display control signal and having a control function of switching directions in which the display control signal is transferred. The address line driver circuit includes a shift register configured to take in the display control signal, a switching circuit configured to switch directions in which the display control signal is transferred in the shift register, and a setting circuit configured to set a direction in which the display control signal is taken in.

### CROSS-REFERENCE TO RELATED APPLICATIONS

This application is based upon and claims the benefit of priority from prior Japanese Patent Application No. 2006-332129, filed Dec. 8, 2006, the entire contents of which are incorporated herein by reference.

### BACKGROUND OF THE INVENTION

1. Field of the Invention

This invention relates to a liquid-crystal display device and its driver circuit. More particularly, this invention relates to a liquid-crystal display device using a liquid-crystal display panel and a liquid-crystal driver integrated circuit (IC) for driving the liquid-crystal panel of the liquid-crystal display device.

2. Description of the Related Art

A liquid-crystal display device (TFT-LCD) using a thin-film transistor (TFT) in its driver circuit for driving a liquid-crystal display (LCD) panel has been realized. The driver circuit used in the liquid-crystal display device is usually configured to drive the address lines of the liquid-crystal display panel by transferring a display control signal (driving signal) according to a transfer clock.

In recent years, a liquid-crystal display device capable of flickerless alternating-current driving has been proposed (e.g., refer to Japanese Patent No. 3061833). In the liquid-crystal display device, a gate driver with a control function of switching directions in which a display control signal is transferred is used as the driver circuit. The gate driver, however, has the following problem.

A conventional gate driver is configured to control the setting of a direction in which the display control signal is taken in (UP/DOWN) and the switching of the transfer direction (For/Rev) using a common U/D control signal. Accordingly, when the transfer direction of the display control signal is reversed, the display control signal from the controller sometimes collides with the display control signal from the internal transfer circuit (S/R), resulting in an increase in the consumption current.

Furthermore, in a recent liquid-crystal display device, a plurality of driver chips are connected in multistage form as a result of the size of the liquid-crystal display panel getting larger. In this case, the last data output/input terminal of the last-stage driver chip is put in the open state (or the floating state). Therefore, when the direction in which the display control signal is transferred is reversed, the last data output/input terminal of the last-stage driver chip goes into the open state. As a result, there is a danger that unexpected data will be taken in by the gate driver, which can result in a malfunction, or defective display.

### BRIEF SUMMARY OF THE INVENTION

According to a first aspect of the invention, there is provided a liquid-crystal display device comprising: a liquid-crystal panel having liquid-crystal display elements to form pixels at intersections of a plurality of address lines lying in a horizontal scanning direction and a plurality of signal lines lying in a vertical scanning direction; a signal line driver circuit configured to drive the signal line at an image signal voltage; and an address line driver circuit configured to drive the address line by a display control signal and having a control function of switching directions in which the display control signal is transferred, wherein the address line driver circuit includes a shift register configured to take in the display control signal, a switching circuit configured to switch directions in which the display control signal is transferred in the shift register, and a setting circuit configured to set a direction in which the display control signal is taken in.

According to a second aspect of the invention, there is provided a driver circuit configured to control switching directions in which a display control signal to drive a plurality of address lines is transferred in a liquid-crystal panel, the driver circuit comprising: at least one semiconductor integrated circuit including a shift register configured to take in the display control signal, a switching circuit configured to generate a switching signal to switch directions in which the display control signal is transferred in the shift register, and a setting circuit configured to generate a setting signal to set a direction in which the display control signal is taken in.

According to a third aspect of the invention, there is provided a driver circuit configured to control switching directions in which a display control signal to drive a plurality of address lines is transferred in a liquid-crystal panel, the driver circuit comprising: a plurality of semiconductor integrated circuits including a shift register configured to take in the display control signal, a switching circuit configured to generate a switching signal to switch directions in which the display control signal is transferred in the shift register, a setting circuit configured to generate a setting signal to set a direction in which the display control signal is taken in, and a dummy shift register configured to store at least a part of the display control signal transferred to the semiconductor integrated circuit at the next stage.

### BRIEF DESCRIPTION OF THE SEVERAL VIEWS OF THE DRAWING

FIG. 1 is a block diagram showing the configuration of a liquid-crystal display device according to a first embodiment of the invention;

FIG. 2 shows the configuration of an address line driver circuit in the liquid-crystal display device of FIG. 1;

FIG. 3 is a timing chart to help explain the operation of the address line driver circuit of FIG. 2;

FIG. 4 shows the configuration of an address line driver circuit according to a second embodiment of the invention;

FIG. 5 is a timing chart to help explain the operation of the address line driver circuit of FIG. 4;

FIG. 6 is a diagram to help explain the operation of the address line driver circuit of FIG. 4;

FIG. 7 is a diagram showing another configuration of the driver chip constituting the address line driver circuit;

FIG. 8 shows the configuration of a DIR signal generator circuit in the driver chip of FIG. 7; and

FIG. 9 shows still another configuration of the driver chip constituting the address line driver circuit.

### DETAILED DESCRIPTION OF THE INVENTION

Embodiments of the invention will be described with reference to the accompanying drawings. It should be noted that the drawings are schematic ones and the dimension ratios shown therein are different from the actual ones. The dimensions vary from drawing to drawing and so do the ratios of dimensions. The following embodiments are directed to a device and a method for embodying the technical concept of the present invention and the technical concept does not specify the material, shape, structure or configuration of components of the present invention. Various changes and modifications can be made to the technical concept without departing from the scope of the claimed invention.

### First Embodiment

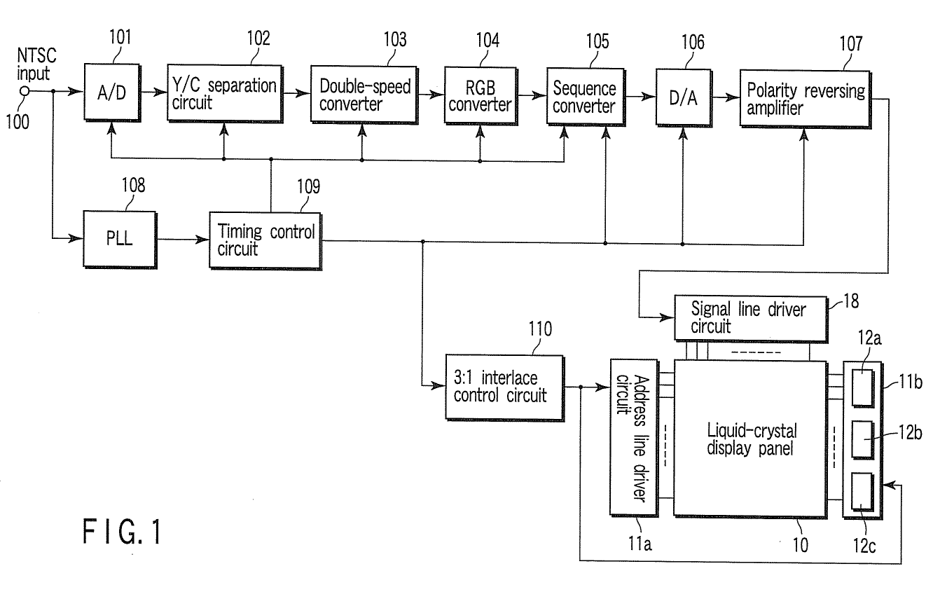

FIG. 1 shows the configuration of a liquid-crystal display device (TFT-LCD) using a thin-film transistor (TFT) in its driver circuit for driving a liquid-crystal display panel according to a first embodiment of the invention. In the first embodiment, a liquid-crystal display device capable of flickerless driving will be explained taking a liquid-crystal TV as an example.

In FIG. 1, for example, an NTSC video signal is input to an input terminal 100. The input video signal is bifurcated into a signal input to an analog-to-digital converter 101 which digitizes the signal and a signal input to a phase-locked loop (PLL) circuit 108 which generates a reference clock signal synchronizing with the input video signal. On the basis of the reference clock signal, a timing control circuit 109 generates timing signals necessary to control various sections.

The video signal digitized by the analog-to-digital converter 101 is first separated by a Y/C separation circuit 102 into a luminance signal (Y signal) and a color-difference signal (C signal). The output of the Y/C separation circuit 102 an NTST interlace signal, which is converted by a double-speed converter circuit 103 into a non-interlace signal. The double-speed converter circuit 103 interpolates the interlace signal and converts the horizontal scanning frequency from 15.73 kHz into 31.47 kHz, that is, makes a double-speed conversion. The double-speed-converted luminance signal and color-difference signal are converted into RGB signals by an RGB converter circuit 106, which are then input to a sequence converter circuit 105.

The sequence converter circuit 105 shifts the RGB signals of the individual scanning lines as the address lines of the liquid-crystal display panel 10 are driven at intervals of an odd number of lines equal to or larger than 3 (in the embodiment, three lines). The sequence converter circuit 105 is composed of, for example, three frame memories (not shown). Specifically, after temporarily storing the input RGB signals into the corresponding memories, the sequence converter circuit 105 reads the signal corresponding to the position of the address line (scanning line) to be driven from the frame memory, thereby outputting the sequence-converted RGB signals.

The sequence-converted RGB signals are converted into analog signals by a digital-to-analog converter 106. Then, after the analog signals are amplified by a polarity reversing amplifier 107 for alternating-current driving to obtain image signals of a suitable magnitude, the image signals are supplied to a signal line driver circuit (source driver) 18. The signal line driver circuit 18 is a circuit which drives all the signal lines of the liquid-crystal display panel 10. In the signal line driver circuit 18, for example, a first and a second integrated circuit (not shown) provided near the liquid-crystal display panel 10 drive the odd-numbered signal lines and the even-numbered lines, respectively, counted from the starting end in the horizontal scanning direction. In this case, the polarity reversing amplifier 107 is controlled by a timing control circuit 109 in such a manner that the polarity of the image signal voltage applied to the odd-numbered signal lines driven by the first integrated circuit is always the opposite of the polarity of the image signal voltage applied to the even-numbered signal lines driven by the second integrated circuit. This enables the alternating-current driving of the liquid-crystal display panel 10.

On the other hand, a 3:1 interlace control circuit 110 controls address line driver circuits (gate drivers) 11a, 11b acting as liquid-crystal drivers IC in such a manner that the address lines of the liquid-crystal display panel 10 are driven sequentially at every third line. In the first embodiment, for example, the address line driver circuit 11a is placed on the left side of the liquid-crystal display panel 10 and the address line driver circuit 11b is placed on the right side of the liquid-crystal display panel 10.

The liquid-crystal display panel 10 is composed of a plurality of address lines lying in the horizontal scanning direction and a plurality of signal lines lying in the vertical scanning direction, and liquid-crystal display elements (not shown) functioning as pixels connected to the intersections of the address lines and the signal lines in a one-to-one correspondence. Each of the pixels has a liquid-crystal cell, a thin-film transistor, and a charge retention capacitor. One end of each of the address lines is connected to the address line driver circuit 11a and the other end is connected to the address line driver circuit 11b.

For example, in the case of a liquid-crystal display device 10 which has 768 address lines and 1280×3 (3840) signal lines, each of the address line driver circuits 11a, 11b includes three driver chips (semiconductor integrated circuits) 12a, 12b, 12c. That is, 256 address lines are connected to each of the driver chips 12a, 12b, 12c.

Next, a flickerless driving method in the above configuration will be explained using an example.

For example, the address lines are driven sequentially at every third line, or at intervals of three lines. At that time, one field period is divided into, for example, sub-three periods. Then, in a first one-third period, the address lines are driven at intervals of three lines in this order: line 1, line 4, . . . , line N-2, starting from the top end of the screen of the liquid-crystal display panel 10. After the address lines have been driven as far as the bottom end of the screen, the address lines, in the next one-third period, are shifted line by line from the first one-third period, starting from the top end of the screen, and driven at intervals of three lines until the bottom end of the screen is reached in this order: line 2, line 5, . . . , line N-1. Thereafter, in the last one-third period, the address lines are driven at intervals of three lines again from the top end of the screen until the bottom end of the screen is reached in this order: line 3, line 6, . . . , line N. This completes one field period.

In this example, in the first field period, the polarity of the image signal voltage applied to the signal lines is reversed alternately in such a manner that the polarity is made positive in the first one-third period, negative in the next one-third period, and positive in the last one-third period. Then, in the second field period, an image signal voltage which has the opposite of the above polarity is applied. By doing this, the individual pixels are driven by alternating current as a result of field reversal, preventing the direct-current component from being accumulated, which makes it possible to eliminate flickers. As described above, if the polarity reversing period of the image signal voltage is a one-third field period, the period of reversal can be made much shorter than one horizontal scanning period (1H) in the line reversing system. Therefore, the flickerless driving method is more advantageous in terms of power consumption.

In the driving of the address lines, for example, the address lines 1, 4, . . . , and N-2 from the top end of the screen are driven by the address line driver circuit 11a. Moreover, the address lines 2, 5, . . . , N-1 are driven by the address line driver circuit 11b. This realizes high-speed driving of the address lines in one field period.

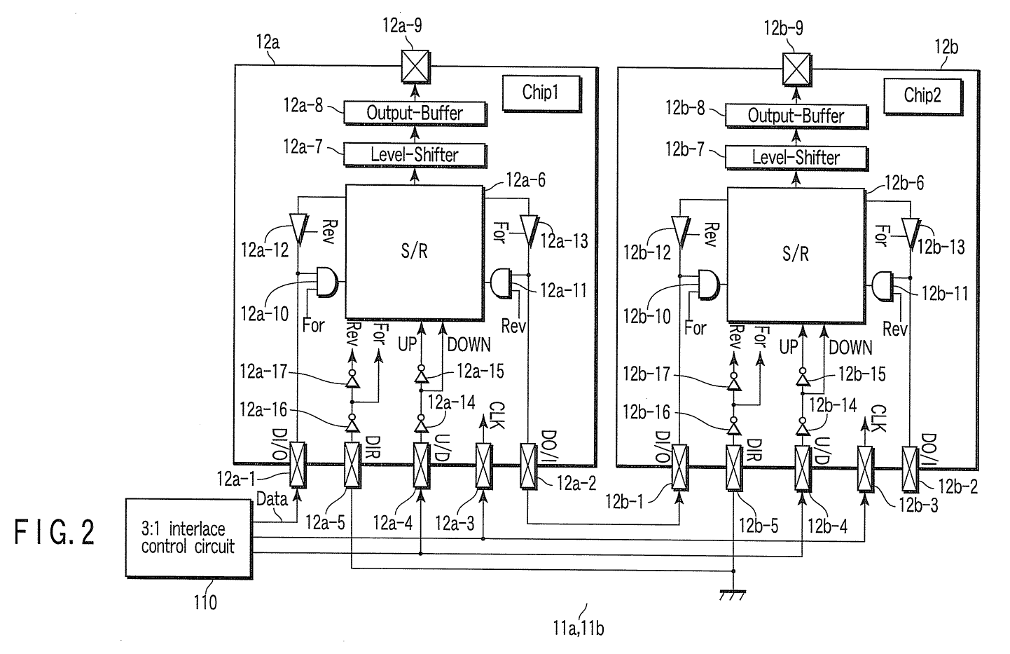

FIG. 2 shows a configuration of each of the address line driver circuits (gate drivers) 11a, 11b. In this example, explanation will be given using a case where each of the address line driver circuits 11a, 11b includes two driver chips (Chip 1, Chip 2).

Driver chips 12a, 12b have the same configuration. Specifically, the driver chip 12a includes a data input/output terminal (DI/O) 12a-1, a data output/input terminal (DO/I) 12a-2, a clock signal (CLK) input terminal 12a-3, a data transfer direction switching signal (U/D control signal) input terminal 12a-4, a data take-in direction setting signal (DIR signal) input terminal 12a-5, and a shift register (S/R) 12a-6. A plurality of display output terminals 12a-9 are connected to the shift register 12a-6 via a level shifter 12a-7 and an output buffer 12a-8. Similarly, the driver chip 12b includes a data input/output terminal 12b-1, a data output/input terminal 12b-2, a clock signal input terminal 12b-3, a data transfer direction switching signal input terminal 12b-4, a data take-in direction setting signal input terminal 12b-5, and a shift register 12b-6. A plurality of display output terminals 12b-9 are connected to the shift register 12b-6 via a level shifter 12b-7 and an output buffer 12b-8.

The output ends of AND circuits 12a-10, 12a-11 are connected to the shift register 12a-6. Moreover, the input ends of buffer circuits 12a-12, 12a-13 are also connected to the shift register 12a-6. One input end of the AND circuit 12a-10 and the output end of the buffer circuit 12a-12 are connected to the data input/output terminal 12a-1. One input end of the AND circuit 12a-11 and the output end of the buffer circuit 12a-13 are connected to the data output/input terminal 12a-2. Similarly, the output ends of AND circuits 12b-10, 12b-11 are connected to the shift register 12b-6. Moreover, the input ends of buffer circuits 12b-12, 12b-13 are also connected to the shift register 12b-6. One input end of the AND circuit 12b-10 and the output end of the buffer circuit 12b-12 are connected to the data input/output terminal 12b-1. One input end of the AND circuit 12b-11 and the output end of the buffer circuit 12b-13 are connected to the data output/input terminal 12b-2.

The data input/output terminals 12a-1, 12b-1 and the data output/input terminals 12a-2, 12b-2 are tristate. A 3:1 interlace control circuit 110 is connected to the data input/output terminal 12a-1 of the driver chip 12a and the data output/input terminal 12a-2 of the driver chip 12a is connected to the data input/output terminal 12b-1 of the driver chip 12b (multistage connection of driver chips). The last data output/input terminal 12b-2 of the driver chip 12b at the last stage is in the open state.

The 3:1 interlace control circuit 110 supplies a U/D control signal for switching data transfer directions at the shift registers 12a-6, 12b-6 to U/D control signal input terminals 12a-4, 12b-4. Inverter circuits 12a-14, 12a-15 are connected in series with the U/D control signal input terminal 12a-4. The inverter circuit 12a-14 generates a DOWN signal (U/D control signal=Low) for reversing the data transfer direction. Moreover, the inverter circuits 12a-14, 12a-15 generate an UP signal (U/D control signal=High) for switching from the present data transfer direction to the forward direction. Similarly, inverter circuits 12b-14, 12b-15 are connected in series with the U/D control signal input terminal 12b-4. The inverter circuit 12b-14 generates a DOWN signal for reversing the data transfer direction. Moreover, the inverter circuits 12b-14, 12b-15 generate an UP signal for switching from the present data transfer direction to the forward direction. The UP signal and DOWN signal are supplied to the shift registers 12a-6, 12b-6.

A DIR signal for setting a data take-in direction at the data input/output terminals 12a-1, 12b-1 and data output/input terminals 12a-2, 12b-2 is externally supplied to the DIR signal input terminals 12a-5, 12b-5. Inverter circuits 12a-16, 12a-17 are connected in series with the DIR signal input terminal 12a-5. The inverter circuit 12a-16 generates a For signal (=High) for setting a data take-in direction to the forward direction. Moreover, the inverter circuits 12a-16, 12a-17 generate a Rev signal (=High) for setting a data take-in direction to the opposite direction. The For signal is supplied not only to the shift register 12a-6 but also to the other input end of the AND circuit 12a-10 and the buffer circuit 12a-13. The Rev signal is supplied not only to the shift register 12a-6 but also to the other input end of the AND circuit 12a-11 and the buffer circuit 12a-12. Similarly, inverter circuits 12b-16, 12b-17 are connected in series with the DIR signal input terminal 12b-5. The inverter circuit 12b-16 generates a For signal for setting a data take-in direction to the forward direction. Moreover, the inverter circuits 12b-16, 12b-17 generate a Rev signal for setting a data take-in direction to the opposite direction. The For signal is supplied not only to the shift register 12b-6 but also to the other input end of the AND circuit 12b-10 and the buffer circuit 12b-13. The Rev signal is supplied not only to the shift register 12b-6 but also to the other input end of the AND circuit 12b-11 and the buffer circuit 12b-12.

The display output terminals 12a-9, 12b-9 are provided according to the number of address lines connected. For example, if the number (total number) of address lines is N and the number of driver chips in one address line driver circuit is c, an N/c number of display output terminals are provided in each driver chip.

The 3:1 interlace control circuit 110 supplies a clock signal CLK to the clock signal input terminals 12a-3, 12b-3. The driver chips 12a, 12b are designed to transfer a display control signal according to the clock signal CLK.

In the first embodiment, the address lines of each of the driver chips 12a, 12b are allocated in the address line driver circuit 11a in this order: line 1, line 2, . . . , line N from the top end of the screen of the liquid-crystal display panel 10. Conversely, the address lines of each of the driver chips 12a, 12b are allocated in the address line driver circuit 11b in this order: line 1, line 2, . . . , line N from the bottom end of the screen. Therefore, the direction in which data is transferred in driving the address lines in the order of line 1, line 2, . . . , line N from the top end of the screen by controlling the address line driver circuit 11a is determined to be the forward direction (U/D control signal High=UP). Conversely, the direction in which data is transferred in driving the address lines in the order of line 1, line 2, . . . , line N from the top end of the screen by controlling the address line driver circuit 11b is determined to be the backward direction (U/D control signal Low=DOWN). With this assumption, explanation will be given below.

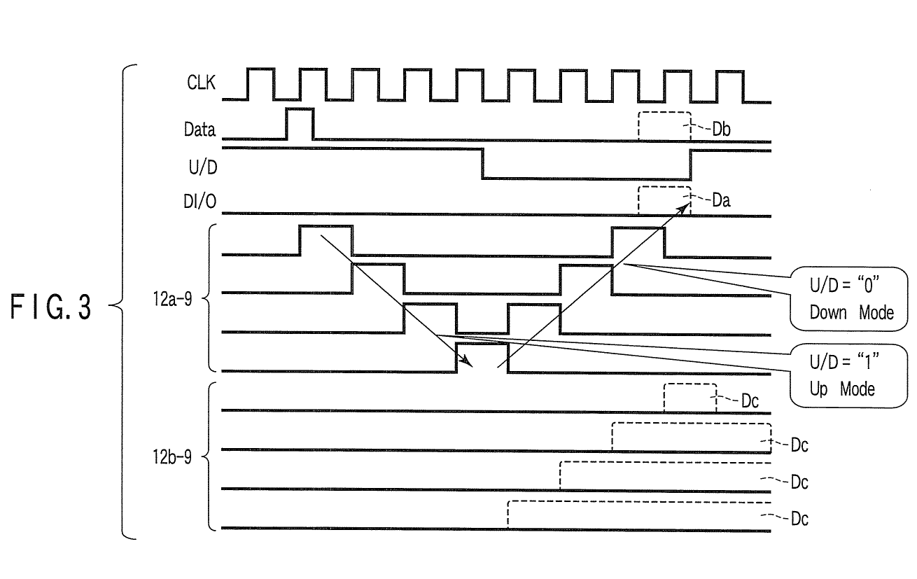

FIG. 3 is a timing chart to help explain the operation of the address line driver circuits 11a, 11b configured as described above. For the sake of simplicity, FIG. 3 shows a case where the number of display output terminals 12a-9 and that of display output terminals 12b-9 are 4 in each of the driver chips 12a, 12b.

For example, in each of the address line driver circuits 11a, 11b, when a DIR signal is a high For signal, a display control signal (Data) from the 3:1 interlace control circuit 110 is taken in by the driver chip 12a via the data input/output terminal 12a-1. Then, the display control signal is sent via the AND circuit 12a-10 to the shift register 12a-6. That is, when the high For signal is supplied to the AND circuit 12a-10, this causes the display control signal from the 3:1 interlace control circuit 110 is transferred to the shift register 12a-6.

When the high For signal, a DIR signal, is supplied to the buffer circuit 12a-13, the display control signal sent to the shift register 12a-6 is sent to the data input/output terminal 12b-1 of the driver chip 12b via the data output/input terminal 12a-2.

When the high For signal, a DIR signal, is supplied to the AND circuit 12b-10, the display control signal is taken in by the driver chip 12b via the data input/output terminal 12b-1. Then, the display control signal is sent via the AND circuit 12b-10 to the shift register 12b-6.

In contrast, when the high Rev signal, a DIR signal, is supplied to the buffer circuit 12b-12, the display control signal in the shift register 12b-6 is sent to the data output/input terminal 12a-2 of the driver chip 12a via the data input/output terminal 12b-1.

Furthermore, when the high Rev signal, a DIR signal, is supplied to the buffer circuit 12a-12, the display control signal of the shift register 12a-6 is sent to the 3:1 interlace control circuit 110 via the data input/output terminal 12a-1.

In the address line driver circuit 11a, when the UP signal is supplied, that is, when the U/D control signal is high, the display control signal in the shift register 12a-6 is transferred to the level shifter 12a-7 and output buffer 12a-8 according to the clock signal CLK. Then, to drive the address lines line by line, the display control signal is output at the corresponding display output terminal 12a-9 sequentially. Similarly, the display control signal in the shift register 12b-6 is transferred to the level shifter 12b-7 and output buffer 12b-8 according to the clock signal CLK. Then, to drive the address lines line by line, the display control signal is output at the corresponding display output terminal 12b-9 sequentially.

On the other hand, in the address line driver circuit 11b, when the DOWN signal is supplied, that is, when the U/D control signal is low, the display control signal in the shift register 12a-6 is transferred to the level shifter 12a-7 and output buffer 12a-8 according to the clock signal CLK. Then, to drive the address lines line by line, the display control signal is output at the corresponding display output terminal 12a-9 sequentially. Similarly, the display control signal in the shift register 12b-6 is transferred to the level shifter 12b-7 and output buffer 12b-8 according to the clock signal CLK. Then, to drive the address lines line by line, the display control signal is output at the corresponding display output terminal 12b-9 sequentially.

As described above, aside from the U/D control signal for switching data transfer directions at the shift registers 12a-6, 12b-6, there is provided the DIR signal for setting a data take-in direction at the data input/output terminals 12a-1, 12b-1 and data output/input terminals 12a-2, 12b-2. This makes it possible to solve the problem of the collision of the display control signal Da from the shift register 12a-6 with the display control signal Db from the 3:1 interlace control circuit 110 even if the U/D control signal is switched so as to reverse the data transfer direction in the shift register 12a-6 in the middle as shown in, for example, FIG. 3. That is, even if the U/D control signal is switched from high (UP signal) to low (DOWN signal), the data take-in direction remains unchanged, preventing the data input/output terminal 12a-1 side from going into the output state. Accordingly, even if the 3:1 interlace control circuit 110 continues sending the display control signal Db, the display control signal Db will never collide with the display control signal Da from the shift register 12a-6. Therefore, the generation of different display control signals Da, Db can be prevented and a malfunction, such as abnormal consumption current caused by the increase of consumption current, can be prevented.

Furthermore, even if the U/D control signal is switched so as to reverse the data transfer direction in the shift register 12a-6 in the middle as shown in, for example, FIG. 3, since the data take-in direction remains unchanged, the last data output/input terminal 12b-2 side of the driver chip 12b at the last stage will never go into the input state. Accordingly, this can solve the problem of the misrecognition of the open input of the data output/input terminal 12b-2 to be originally held low and the output of unexpected data Dc at the display output terminal 12b-9. Therefore, it is possible to prevent a malfunction, such as defective display.

As described above, aside from the U/D control signal for switching data transfer directions at the shift registers, the DIR signal for setting the data take-in direction is provided. That is, in the address line driver circuit with the function of switching directions in which the display control signal is transferred, a U/D control signal and a DIR signal are prepared separately. This makes it possible to independently control the switching of the data transfer direction in the shift registers and the setting of the data take-in direction. Accordingly, even when the direction in which the display control signal is transferred is switched in the middle of display, a malfunction, such as defective display or abnormal consumption current, can be prevented, which always assures a normal operation.

### Second Embodiment

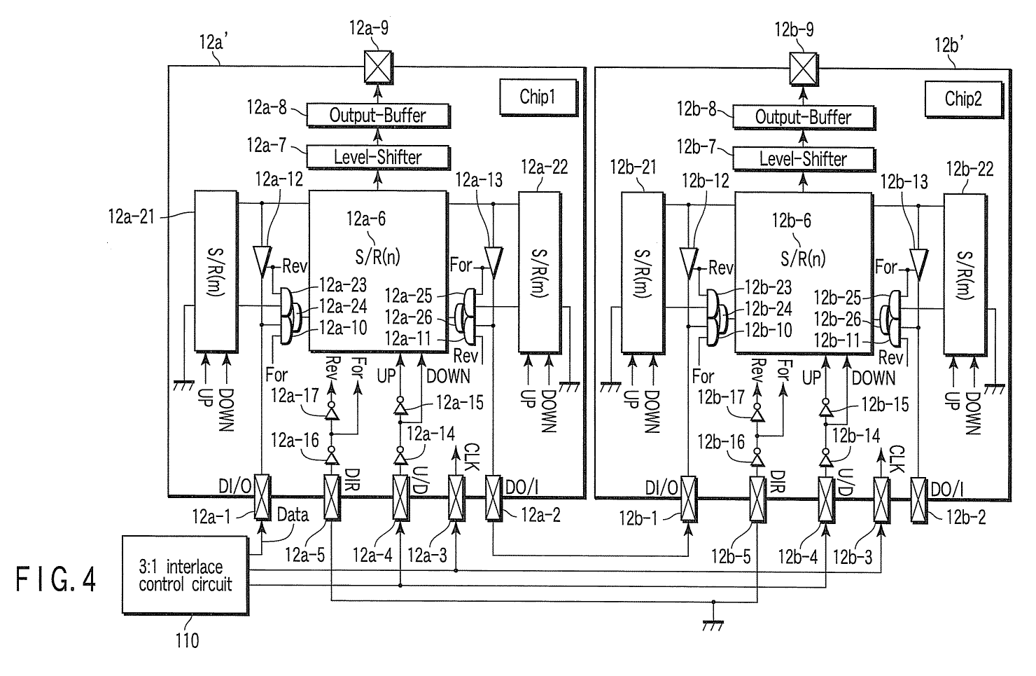

FIG. 4 shows the configuration of an address line driver circuit according to a second embodiment of the invention. In the second embodiment, the address lines can be driven properly in transferring data in the opposite direction between driver chips. In FIG. 4, the same parts as those in the address line driver circuit of FIG. 2 are indicated by the same reference numerals and a detailed explanation of the second embodiment will be omitted.

In the second embodiment, driver chips (Chip 1, Chip2) 12a′, 12b′ include dummy shift registers (S/R(m)) 12a-21, 12b-21 and dummy shift registers 12a-22, 12b-22 for holding a display control signal transferred to the driver chips at the following stage, respectively. Specifically, the driver chips 12a, 12b′ have the same configuration. The shift register 12a-21 and shift register 12a-22 are added to the driver chip 12a′. The shift register 12b-21 and shift register 12b-22 are added to the driver chip 12b′.

U/D control signals (UP signal/DOWN signal) for switching data transfer directions at the shift registers (S/R(n)) 12a-6, 12b-6 are supplied to the shift registers 12a-21, 12b-21 and shift registers 12a-22, 12b-22.

The input end of the shift register 12a-6 and the buffer circuit 12a-12 is connected to the shift register 12a-21. Moreover, one input end of an AND circuit 12a-23 is connected to the shift register 12a-21. A Rev signal, a DIR signal for setting a data take-in direction, is supplied to the other input end of the AND circuit 12a-23. The output end of the AND circuit 12a-23 is connected to one input end of an OR circuit 12a-24. The output end of the AND circuit 12a-10 is connected to the other input end of the OR circuit 12a-24. The output end of the OR circuit 12a-24 is connected to the shift register 12a-6.

The input end of the shift register 12a-6 and the buffer circuit 12a-13 is connected to the shift register 12a-22. Moreover, one input end of an AND circuit 12a-25 is connected to the shift register 12a-22. A For signal, a DIR signal for setting a data take-in direction, is supplied to the other input end of the AND circuit 12a-25. The output end of the AND circuit 12a-25 is connected to one input end of an OR circuit 12a-26. The output end of the AND circuit 12a-11 is connected to the other input end of the OR circuit 12a-26. The output end of the OR circuit 12a-26 is connected to the shift register 12a-6.

Similarly, the input end of the shift register 12b-6 and the buffer circuit 12b-12 is connected to the shift register 12b-21. Moreover, one input end of an AND circuit 12b-23 is connected to the shift register 12b-21. A Rev signal, a DIR signal for setting a data take-in direction, is supplied to the other input end of the AND circuit 12b-23. The output end of the AND circuit 12a-23 is connected to one input end of an OR circuit 12a-24. The output end of the AND circuit 12b-10 is connected to the other input end of the OR circuit 12b-24. The output end of the OR circuit 12b-24 is connected to the shift register 12b-6.

The input end of the shift register 12b-6 and the buffer circuit 12b-13 is connected to the shift register 12b-22. Moreover, one input end of an AND circuit 12b-25 is connected to the shift register 12b-22. A For signal, a DIR signal for setting a data take-in direction, is supplied to the other input end of the AND circuit 12b-25. The output end of the AND circuit 12b-25 is connected to one input end of an OR circuit 12b-26. The output end of the AND circuit 12b-11 is connected to the other input end of the OR circuit 12b-26. The output end of the OR circuit 12b-26 is connected to the shift register 12b-6.

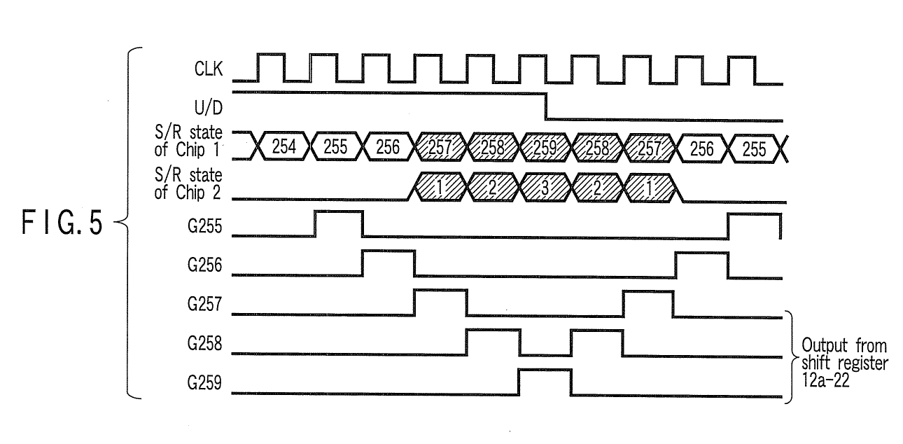

In the configuration of the second embodiment, suppose a display control signal is transferred from the driver chip 12a′ to the driver chip 12b′ as shown in, for example, FIG. 5. At this time, if the number of address lines driven by one driver chip is 256, the driver chip 12a′ transfers, for example, display control signals G257, G258, G259 for driving the address lines excluding the address lines able to be driven to the driver chip 12b′. At the same time, the driver chip 12b′ stores, for example, display control signals G257, G258, G259 into the dummy shift register 12b-22.

In this state, when the data transfer direction is switched and a display control signal is transferred from the driver chip 12b′ to the driver chip 12a′, the display control signals G257, G258, G259 stored in the dummy shift register 12b-22 are read and transferred to the shift register 12a-6.

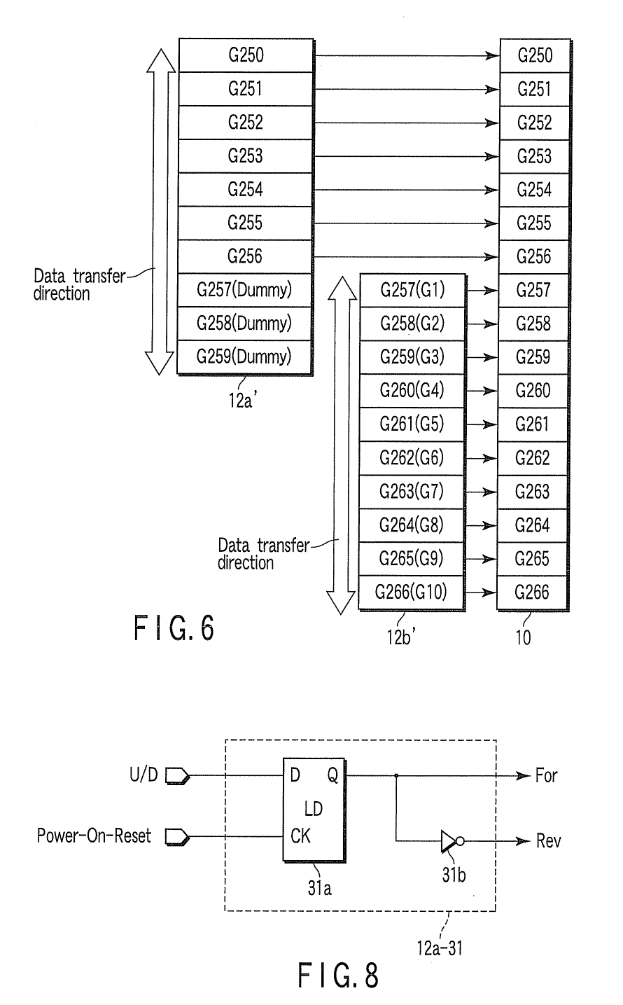

In the operation of FIG. 6, the data on the address lines corresponding to lines 257, 258, 259 on the liquid-crystal display panel 10 are also stored in Dummy (257), Dummy (258), and Dummy (259). Therefore, when the data transfer direction is switched and reversed, using the dummy data makes it possible to output the proper display control signal to G254, G255, G256.

As described above, with the configuration of the second embodiment, the display control signal once transferred to the driver chip 12b′ at the next stage which could not be taken in even if the data transfer direction were switched can be taken in spuriously by the driver chip 12a′. Therefore, even when data is transferred in the opposite direction between the driver chips 12a′ and 12b′, the address lines can be driven properly.

### Other Embodiments

In the first and second embodiments, the DIR signal has been supplied from outside the driver chips. The invention is not limited to this. For instance, a driver chip may be configured to generate a DIR signal therein.

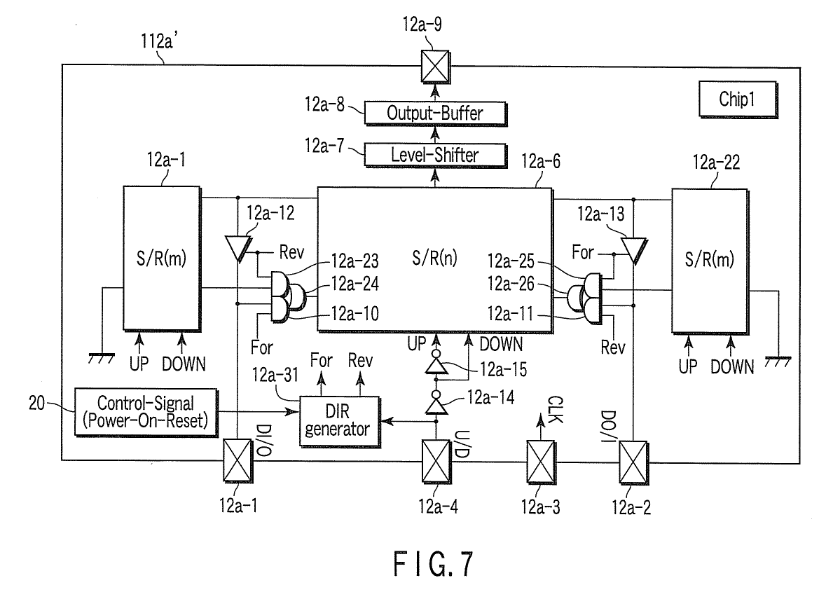

FIG. 7 shows another configuration of the driver chip applicable to the first and second embodiments. In this embodiment, explanation will be given taking the driver chip 12a′ of FIG. 4 as an example. In FIG. 7, the same parts as those of the drive chip 12a′ are indicated by the same reference numerals and a detailed explanation will be omitted.

As shown in FIG. 7, in the driver chip (Chip 1) 112a′, there is provided a DIR signal generator circuit 12a-31 which generates a DIR signal (For signal/Rev signal) using the control signal from a power-on reset circuit 20. The DIR signal generator circuit 12a-31 is configured to determine a data take-in direction by taking in a U/D control signal in the power-on reset state.

FIG. 8 shows a configuration of the DIR signal generator circuit 12a-31. The DIR signal generator circuit 12a-31 includes, for example, a flip-flop circuit (LD) circuit 31a and an inverter circuit 31b. The DIR signal generator circuit 12a-31 causes the flip-flop circuit 31a to generate a For signal from the control signal from the power-on reset circuit 20 and the U/D control signal and outputs the For signal. Furthermore, the DIR signal generator circuit 12a-31 causes the inverter circuit 31b to invert the For signal to produce a Rev signal and outputs the Rev signal.

As described above, when a DIR signal is generated, using the control signal from the power-on reset circuit at the start-up of the power supply enables a data take-in direction to be set without supplying a DIR signal from outside the driver chip. Moreover, since the data take-in direction remains unchanged while the power is being supplied stably, the address lines can be driven properly.

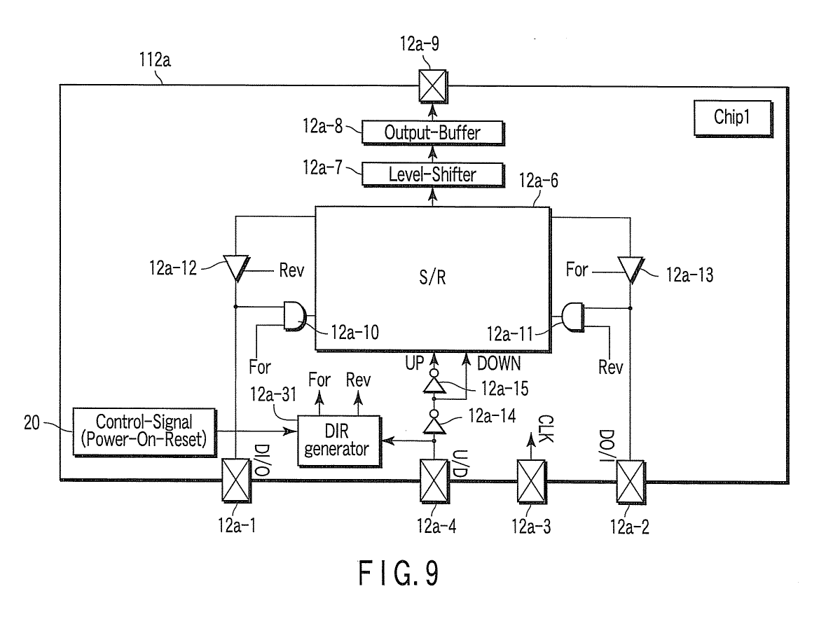

This invention is not limited to the driver chip 12a′ with the configuration of FIG. 4. For instance, the driver chip 12a with the configuration of FIG. 2 may be configured to generate a DIR signal using the control signal from the power-on reset circuit 20. That is, the driver chip 12a with the configuration of FIG. 2 may be configured to generate a DIR signal using the DIR signal generator circuit 12a-31 as is the driver chip (Chip 1) 112a of FIG. 9, for example.

Furthermore, in each of the above embodiments, as long as an address line driver circuit has the function of switching directions in which the display control signal is transferred, the invention can be applied to the address line driver circuit. The invention is not restricted to a method of driving the address lines at intervals of, for example, one line or three lines.

Moreover, the liquid-crystal display device in which the address line driver circuits of the embodiments are used is not limited to the one in which address line driver circuits are located on the right and left sides of the liquid-crystal display panel. That is, the invention, of course, can be applied to a liquid-crystal display device where address line driver circuits are located only on one of the right and left sides of the liquid-crystal display panel.

In addition, the address line driver circuit has only to have at least one driver chip.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid-crystal display device comprising:
a liquid-crystal panel having liquid-crystal display elements to form pixels at intersections of a plurality of address lines lying in a horizontal scanning direction and a plurality of signal lines lying in a vertical scanning direction;
a signal line driver circuit configured to drive the signal line at an image signal voltage; and
an address line driver circuit configured to drive the address line by a display control signal and having a control function of switching directions in which the display control signal is transferred,
wherein the address line driver circuit includes
a shift register configured to take in the display control signal,
a switching circuit configured to switch directions in which the display control signal is transferred in the shift register, and
a setting circuit configured to set a direction in which the display control signal is taken in.

2. The liquid-crystal display device according to claim 1, wherein the address line driver circuit includes at least one semiconductor integrated circuit and the semiconductor circuit has the shift register, the switching circuit, and the setting circuit.

3. The liquid-crystal display device according to claim 2, wherein the setting circuit generates a setting signal to set a direction in which the display control signal is taken in based on a control signal supplied from outside the semiconductor integrated circuit.

4. The liquid-crystal display device according to claim 2, wherein the setting circuit generates a setting signal to set a direction in which the display control signal is taken in based on a control signal generated inside the semiconductor integrated circuit.

5. The liquid-crystal display device according to claim 4, wherein the setting circuit generates the setting signal based on a power-on reset signal and a switching signal to switch directions in which the display control signal is transferred.

6. The liquid-crystal display device according to claim 2, wherein the semiconductor integrated circuit includes a dummy shift register storing at least a part of the display control signal transferred to the semiconductor integrated circuit at the next stage.

7. The liquid-crystal display device according to claim 6, wherein said at least a part of the display control signal stored in the dummy shift register is read out to be transferred to the semiconductor integrated circuit at the preceding stage according to the switching of the transfer direction of the display control signal.

8. The liquid-crystal display device according to claim 1, wherein the address line driver circuit includes a first address line driver circuit arranged on one side of the liquid-crystal panel and a second address line driver circuit arranged on the other side of the liquid-crystal panel and in a position facing the first address line driver circuit, one end of the address line being connected to the first address line driver circuit and the other end of the address line being connected to the second address line driver circuit.

9. A driver circuit configured to control switching directions in which a display control signal to drive a plurality of address lines is transferred in a liquid-crystal panel, the driver circuit comprising:
at least one semiconductor integrated circuit including
a shift register configured to take in the display control signal,
a switching circuit configured to generate a switching signal to switch directions in which the display control signal is transferred in the shift register, and
a setting circuit configured to generate a setting signal to set a direction in which the display control signal is taken in.

10. The driver circuit according to claim 9, wherein the setting circuit generates the setting signal based on a control signal supplied from outside the semiconductor integrated circuit.

11. The driver circuit according to claim 9, wherein the setting circuit generates the setting signal based on a control signal generated inside the semiconductor integrated circuit.

12. The driver circuit according to claim 9, wherein the setting circuit generates the setting signal based on a power-on reset signal and the switching signal.

13. The driver circuit according to claim 9, wherein the semiconductor integrated circuit includes a dummy shift register storing at least a part of the display control signal transferred to the semiconductor integrated circuit at the next stage.

14. The driver circuit according to claim 13, wherein said at least a part of the display control signal stored in the dummy shift register is read out to be transferred to the semiconductor integrated circuit at the preceding stage according to the switching of the transfer direction of the display control signal.

15. A driver circuit configured to control switching directions in which a display control signal to drive a plurality of address lines is transferred in a liquid-crystal panel, the driver circuit comprising:
a plurality of semiconductor integrated circuits including
a shift register configured to take in the display control signal,
a switching circuit configured to generate a switching signal to switch directions in which the display control signal is transferred in the shift register,
a setting circuit configured to generate a setting signal to set a direction in which the display control signal is taken in, and
a dummy shift register configured to store at least a part of the display control signal transferred to the semiconductor integrated circuit at the next stage.

16. The driver circuit according to claim 15, wherein the setting circuit generates the setting signal based on a control signal supplied from outside the semiconductor integrated circuit.

17. The driver circuit according to claim 15, wherein the setting circuit generates the setting signal based on a control signal generated inside the semiconductor integrated circuit.

18. The driver circuit according to claim 15, wherein the setting circuit generates the setting signal based on a power-on reset signal and the switching signal.

19. The driver circuit according to claim 15, wherein said at least a part of the display control signal stored in the dummy shift register is read out to be transferred to the semiconductor integrated circuit at the preceding stage according to the switching of the transfer direction of the display control signal.
